(19) United States
(12) Patent Application Publication
(10) Pub. No.: US 2021/0081904 A1
(43) Pub. Date: Mar. 18, 2021

(54) COMPUTER IMPLEMENTED METHOD FOR AUTOMATIC ASSIGNMENT AND REASSIGNMENT OF FLEXIBLE DELIVERY WORK

(71) Applicant: COUPANG CORP., Seoul (KR)

(72) Inventor: Jungsup SONG, Incheon (KR)

(73) Assignee: Coupang Corp.

(21) Appl. No.: 16/571,442

(22) Filed: Sep. 16, 2019

(51) Int. Cl. G06Q 10/10; G06Q 10/08; G06Q 10/06; G06Q 50/30

(52) U.S. Cl. CPC G06Q 10/1097; G06Q 10/0835; G06Q 50/30; G06Q 10/063114; G06Q 10/087

(57) ABSTRACT

Disclosed embodiments provide computer-implemented systems and methods related to automatically assigning and reassigning delivery tasks to delivery workers. The systems and methods may access databases storing information associated with delivery tasks and delivery workers, assign the delivery tasks to the delivery workers, and reassign the delivery tasks to find better combinations between the assigned delivery tasks and the delivery workers.

### TECHNICAL FIELD

The present disclosure generally relates to computerized systems and methods for an automatic assignment of delivery tasks. In particular, embodiments of the present disclosure relate to inventive and unconventional systems relate to computerized automatic delivery task assignment and reassignment for temporary delivery workers.

### BACKGROUND

Fulfillment centers (FCs) encounter more than millions of products daily as they operate to fulfill consumer orders as soon as the orders are placed and enable delivery workers to pick up shipments. Operations for enabling delivery workers to pick up shipments may include assigning a delivery worker to a delivery task. Although currently existing FCs and computerized systems for assigning workers are configured to handle large volumes of delivery tasks, a common issue arises when a FC receives orders that cannot be handled by delivery workers associated with the FC.

To mitigate such problems, conventional delivery assignment systems may assign temporary delivery workers, for example, workers delivering on an as-needed basis (e.g., seasonally), to perform delivery tasks. While these computerized systems attempt to assign delivery tasks in an efficient manner, the systems relied upon a human user to review a table of expected and actual workload values and determine assignments of temporary delivery workers to a delivery task. For example, a manager in charge of assigning delivery tasks may review an electronic document listing expected and actual workload of delivery tasks, including a volume of parcels for each delivery task, and determine whether or not a temporary delivery worker is required. The manager may then manually assign temporary delivery workers to unassigned tasks.

Therefore, there is a need for improved methods and systems for an automatic delivery task assignment of temporary delivery workers.

### SUMMARY

One aspect of the present disclosure is directed to a computer-implemented system for providing delivery assignment. The system may include one or more memory devices storing instructions. The system may also include one or more processors configured to execute the instructions to perform operations. The operations comprise receiving a request to assign delivery tasks to a group of delivery workers from a user device, accessing a first database storing delivery tasks, each delivery task associated with properties including a delivery location, a volume of parcels, and an assigned volume of parcels, and accessing a second database storing information associated with delivery workers, each delivery worker associated with one or more desired delivery areas, and a desired delivery volume. When a delivery location of a first delivery task is within a desired delivery area of a first delivery worker, and a sum of an assigned volume of parcels of the first delivery task and a desired delivery volume of the first delivery worker is less than or equal to a volume of parcels of the first delivery task, the operations further comprise assigning the first delivery task to the first delivery worker and adjusting the assignment status of the first delivery worker to assigned and the assigned volume of parcels of the first delivery task by adding the desired delivery volume. After initial assignments, the operations further comprise reassigning the delivery tasks among assigned delivery workers by swapping the delivery tasks when the assigned volume of parcels of the delivery task is greater than or equal to the volume of parcels of the delivery task.

Another aspect of the present disclosure is directed to a computer-implemented system for providing delivery assignment. The system may include one or more memory devices storing instructions. The system may also include one or more processors configured to execute the instructions to perform operations. The operations comprise receiving a request to assign a group of delivery workers to delivery tasks from a user device, accessing a first database storing delivery tasks, each delivery task associated with properties including a delivery location and a volume of parcels, and accessing a second database storing information associated with delivery workers, each delivery worker associated with an assignment status, one or more desired delivery areas, a desired delivery volume, and an assigned volume of parcels. when a delivery location of a first delivery task is within a desired delivery area of a first delivery worker, and a sum of an assigned volume of parcels of the first delivery worker and a volume of parcels the first delivery task is less than or equal to a desired delivery volume of the first delivery worker, the operations further comprise assigning the first delivery worker to a first delivery task and adjusting the assignment status of the first delivery task to assigned and the assigned volume of parcels of the first delivery task by adding the delivery volume of parcels.

Yet another aspect of the present disclosure is directed to a computer-implemented system for providing delivery assignment. The system may include one or more memory devices storing instructions. The system may also include one or more processors configured to execute the instructions to perform operations. The operations comprise receiving a request to assign delivery tasks to a group of delivery workers from a user device, accessing a first database storing delivery tasks, each delivery task associated with properties including a delivery location, a volume of parcels, and an assigned volume of parcels, wherein the delivery location includes one or more neighboring destinations within a residential complex, and accessing a second database storing information associated with delivery workers, each delivery worker associated with one or more desired delivery areas, and a desired delivery volume. When a delivery location of a first delivery task is within a desired delivery area of a first delivery worker, and a sum of an assigned volume of parcels of the first delivery task and a desired delivery volume of the first delivery worker is less than or equal to a volume of parcels of the first delivery task, the operations further comprise assigning the first delivery task to the first delivery worker and adjusting the assignment status of the first delivery worker to assigned and the assigned volume of parcels of the first delivery task by adding the desired delivery volume. After initial assignments, the operations further comprise reassigning the delivery tasks among assigned delivery workers by swapping the delivery tasks when the assigned volume of parcels of the delivery task is greater than or equal to the volume of parcels of the delivery task.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is an exemplary flow chart of process for automatically scheduling delivery tasks for occasional delivery workers, consistent with the disclosed embodiments.

FIG. 4 is an exemplary flow chart of process for automatically assigning and reassigning delivery tasks to occasional delivery workers, consistent with the disclosed embodiments.

FIG. 5 is an exemplary flow chart of process for automatically assigning occasional delivery workers to delivery tasks, consistent with the disclosed embodiments.

FIG. 6A depicts exemplary information associated with occasional delivery workers stored in a database, consistent with the disclosed embodiments.

FIG. 6B depicts exemplary delivery tasks stored in a database, consistent with the disclosed embodiments.

FIG. 6C depicts exemplary delivery tasks comprising sub-routes stored in a database, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to an automatic systems and methods configured for assigning a temporary delivery worker to a delivery task. The disclosed embodiments provide innovative technical features that allow for automated temporary delivery worker assignments by executing one or more delivery assignments and reassignments to maximize delivery parcel allocation or delivery worker assignments by utilizing information associated with delivery tasks and temporary delivery workers. For example, the disclosed embodiments enable transmission of a request for a delivery tasks assignment, enable access of information associated with delivery tasks and temporary delivery workers, and enable optimization of delivery assignments by running variety of automatic assignments and reassignments on the delivery tasks and the temporary delivery workers to find optimal combinations.

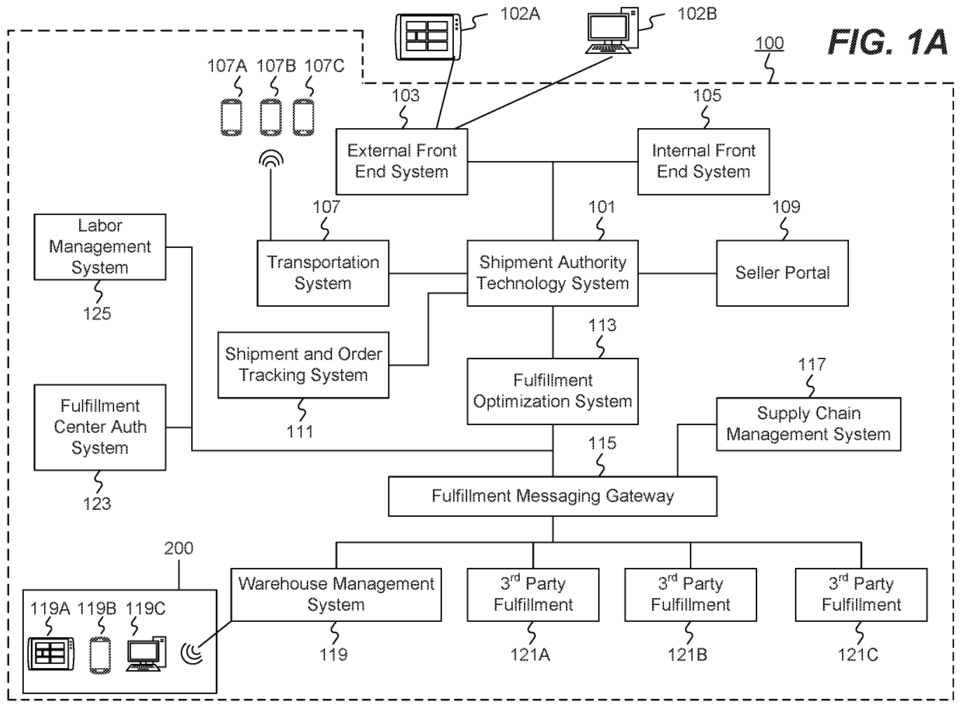

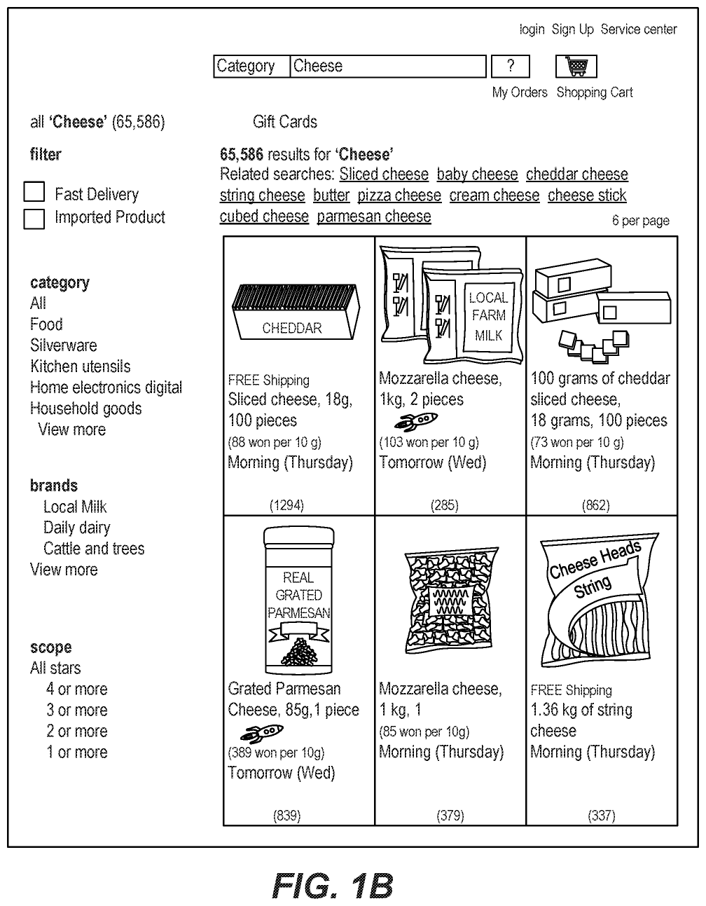

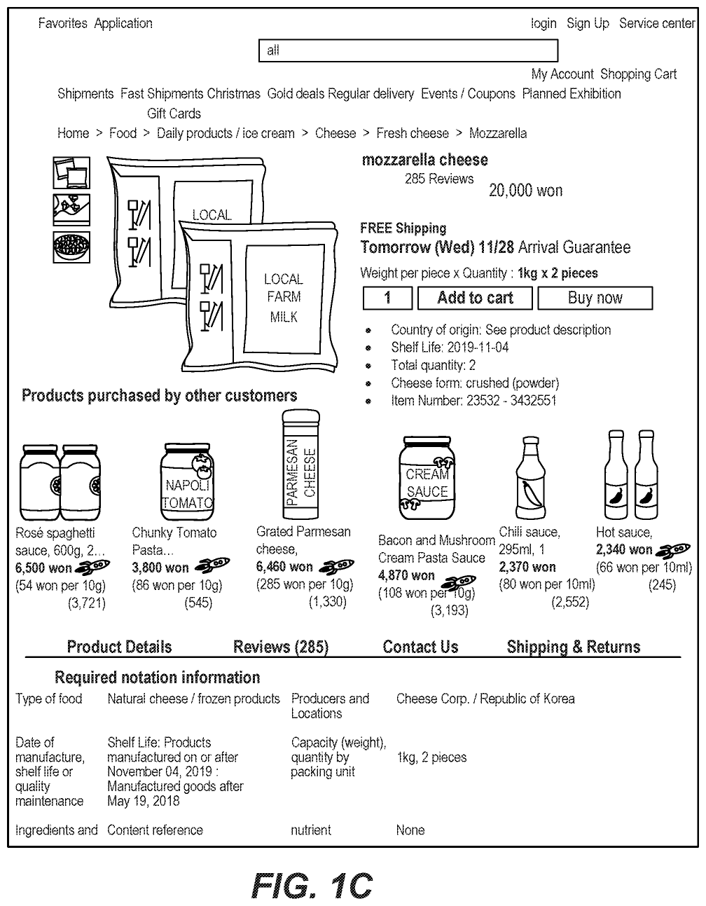

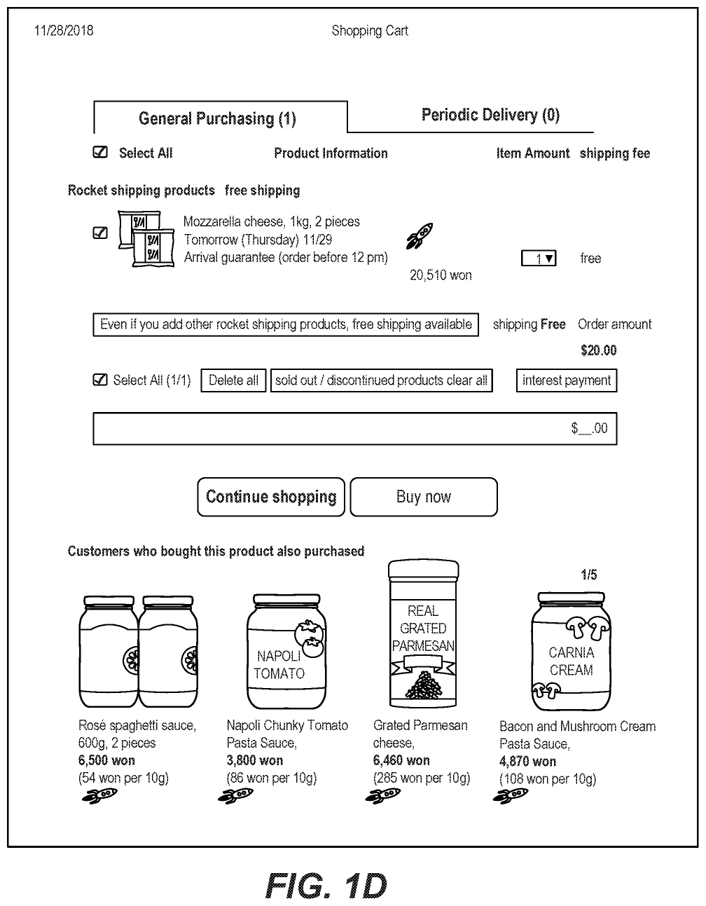

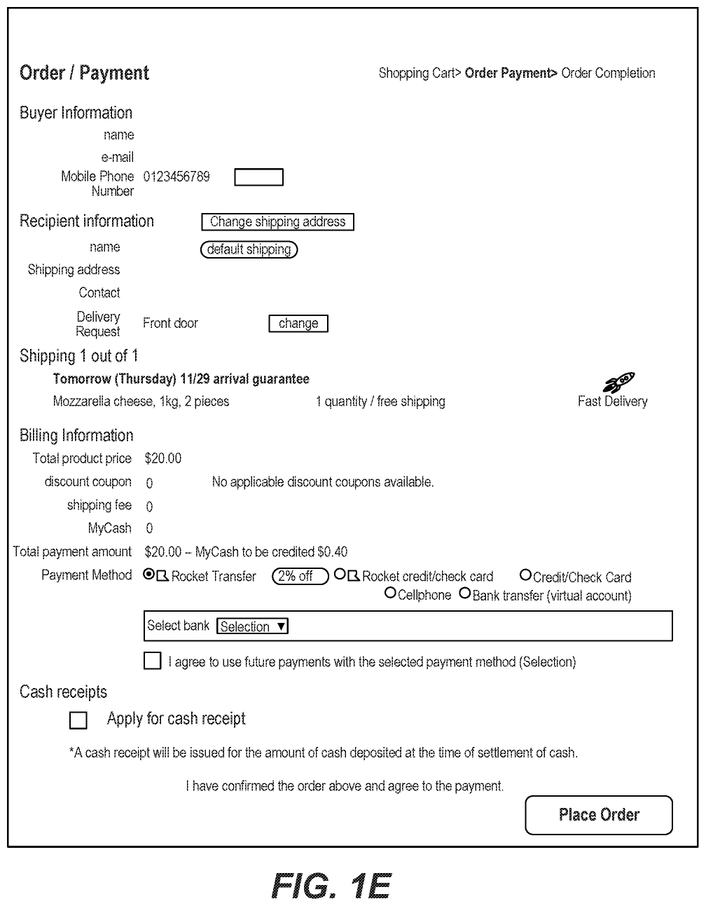

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

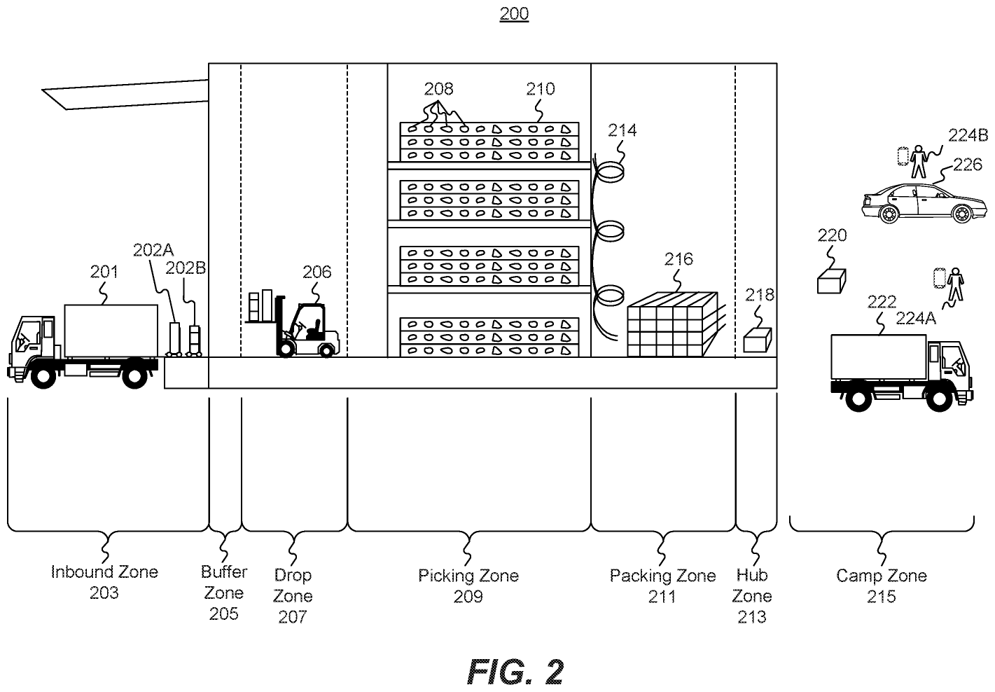

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

According to an aspect of the present disclosure, a computer-implemented system for assigning and reassigning delivery tasks to temporary delivery workers may comprise one or more memory devices storing instructions, and one or more processors configured to execute the instructions to perform operations. In some embodiments, the disclosed functionality and systems may be implemented as part of one or more of transportation system 107 or SAT system 101. The preferred embodiment comprises implementing the disclosed functionality and systems on transportation system 107, but one of ordinary skill will understand that other implementations are possible.

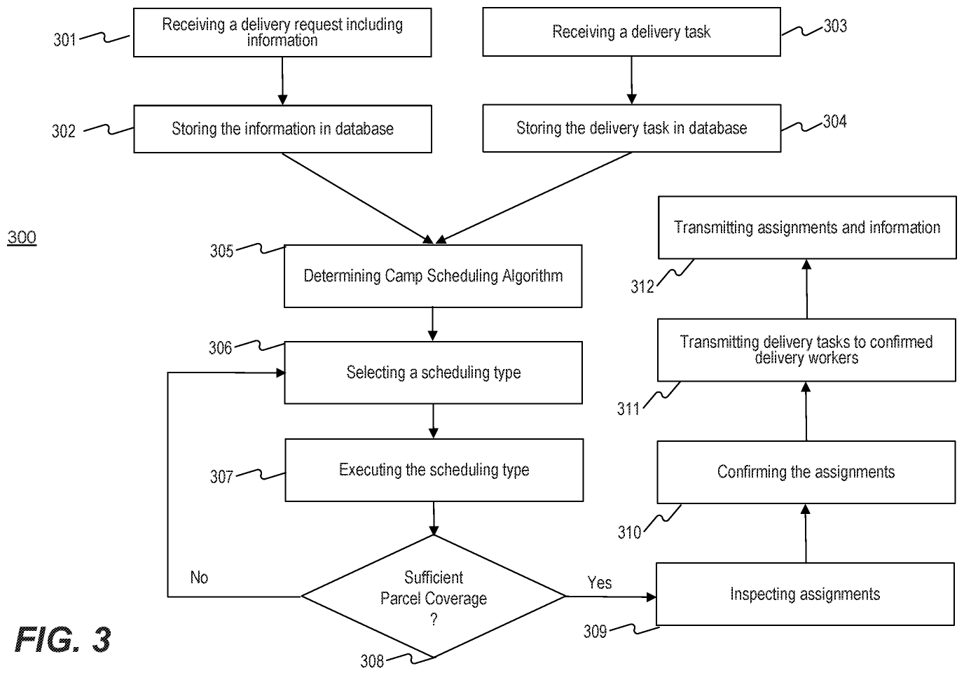

FIG. 3 is an exemplary flow chart of process 300 for automatically scheduling delivery tasks for occasional delivery workers 224B, consistent with the disclosed embodiments. This exemplary process is provided by way of example. Process 300 shown in FIG. 3 can be executed or otherwise performed by one or more combinations of various systems, but the preferred embodiment comprises executing process 300 on transportation system 107. Each block shown in FIG. 3 represents one or more processes, methods, or subroutines in the exemplary method 300. Referring to FIG. 3, exemplary method 300 may begin at block 301.

In step 301 transportation system 107 may receive a delivery task request including information associated with an occasional delivery worker 224B from a mobile device 107A-C. The information may include, a name, a status, a phone number, a vehicle information, a desired camp storing delivery parcels for the delivery worker to pick up the parcels, one or more desired delivery areas, a desired range of delivery volume, an indicator for drop-off tasks, or other preferences from the delivery worker.

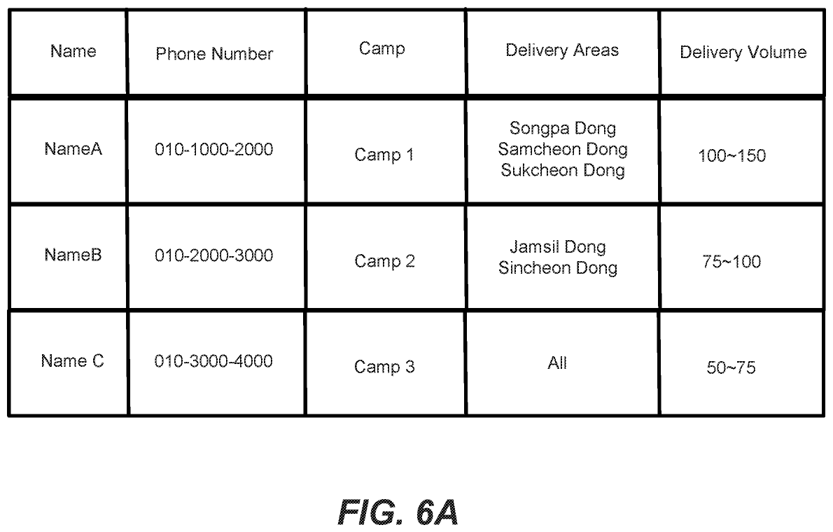

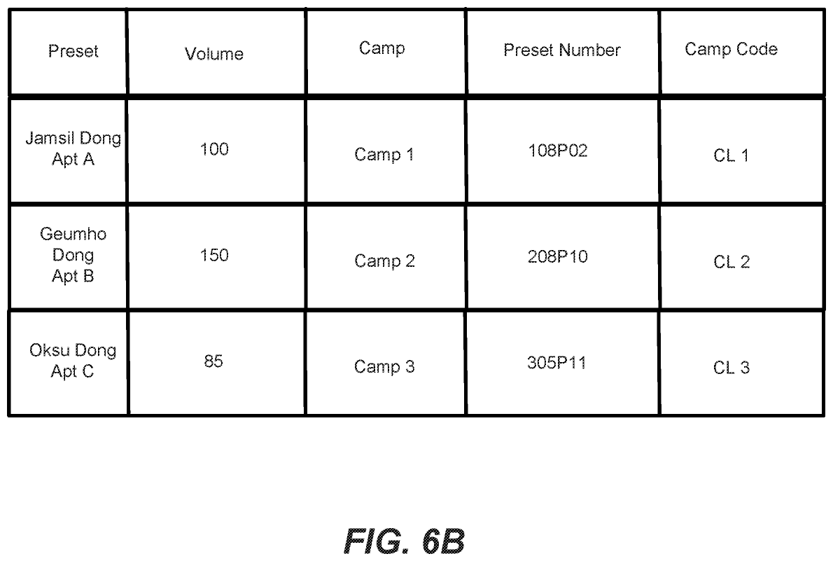

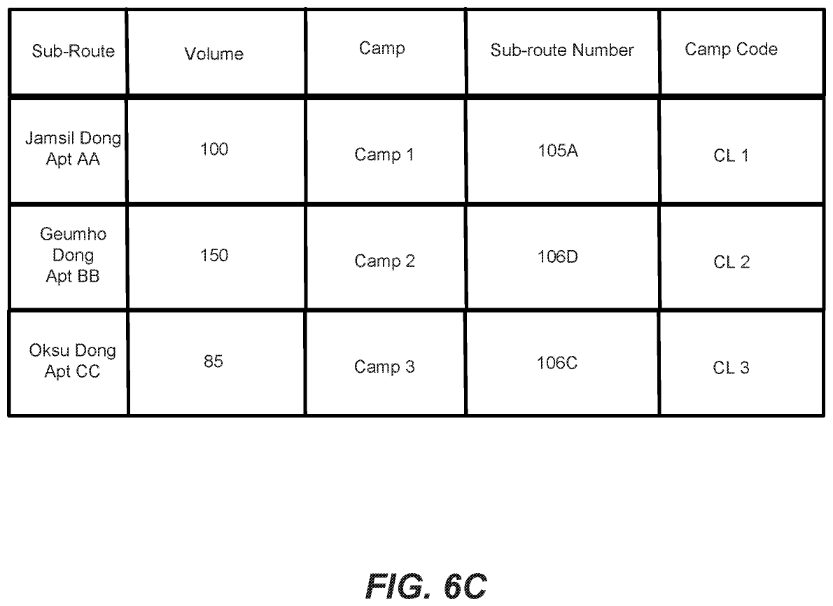

In step 302, transportation system 107 may store the request and the information in a database (not pictured). The database is described above as a database storing information from transportation system 107 for access by other systems in network 100. The stored information may be in the form of a table as depicted in FIG. 6A. Transportation system 107 may classify the information in one of many regions to reduce a delivery worker management risk and a complexity for scheduling delivery assignments, and to secure flexibility. For example, as shown in FIG. 6A, information is classified to EAST region. The regions may include one or more camps where occasional delivery workers 224B pick up delivery parcels.

Transportation system 107 may repeat steps 301 and 302 when it receives new requests from occasional delivery workers to provide the most up-to-date information for executing a scheduling type in step 307 which is described below in more detail.

In step 303 transportation system 107 may receive a delivery task from SAT system 101. SAT system 101, as described above with respect to FIG. 1A, is implemented as a computer system that monitors order status and delivery status. SAT system 101 may predict a volume of parcels for each delivery task, define information for each delivery task, and transmit the delivery task to transportation system 107. The information may include a delivery location, a volume of parcels, an identifier associated with a delivery task, a camp, and an identifier associated with the camp.

In step 304, transportation system 107 may store the delivery task received in step 303 in a database (not pictured). The database is described above as a database storing information from transportation system 107 for access by other systems in network 100. The stored delivery task may be in the form of table as depicted in FIG. 6B. Transportation system 107 may classify the delivery task in one of many regions. For example, as shown in FIG. 6B, delivery task is classified to the “EAST” region.

In some embodiments, steps 301 and 303 may operate substantially simultaneously or consecutively.

In some embodiments, transportation system 107 may store a delivery task associated with a delivery location comprising one or more delivery destinations called sub-routes. For example, delivery destinations (sub-routes) may comprise one or more units in an apartment complex. Transportation system 107 may determine a delivery task based on a delivery destination associated with each delivery parcel. For example, transportation system 107 may group delivery parcels with same or close postal code and assign the grouped parcels to a delivery task. Determination of delivery task may further include considering a calculation of workload for each delivery task, a time of day, a shipping method, a cost to ship the parcel, a PDD associated with the parcels, or the like. The stored delivery task associated with sub-routes may be in the form of table as depicted in FIG. 6C. The table may comprise a sub-route (e.g., a residential complex), a volume of parcels, a camp (e.g., a location where items are packed for shipping), an identifier associated with sub-route, and an identifier associated with the camp. Transportation system 107 may classify the delivery task in one of many regions. For example, delivery tasks may be classified in the “EAST” region.

In some embodiments, transportation system 107 may store a delivery task, requiring occasional delivery workers 224B to pick up delivery parcels at the delivery location, called “drop-off.” For example, the delivery location may be a residential complex including one or more neighboring residential buildings. Delivery parcels associated with a drop-off delivery task are delivered to the delivery location in batch, and occasional delivery workers 224B who volunteered for drop-off delivery tasks may pick up the delivery parcels from the delivery location to deliver the parcels to its final destinations within the residential complex.

In step 305, transportation system 107 may determine a camp scheduling algorithm based on total parcel volumes for all delivery tasks and total desired delivery volumes for all occasional delivery workers 224B. The camp scheduling algorithm may be chosen from one or both of Maximum Parcel Allocation and Maximum Candidate Assignment. Transportation system 107 may choose the Maximum Parcel Allocation algorithm to ensure that all parcel volumes of delivery tasks are assigned when the total volume of delivery tasks exceeds total desired delivery volumes of occasional delivery worker 224B. Each occasional delivery worker 224B selects a range of a desired number of parcels for delivery. By choosing Maximum Parcel Allocation, transportation system 107 chooses the maximum value of each range for each occasional delivery worker. Transportation system 107 may choose the Maximum Candidate Assignment to ensure that greatest number of occasional delivery workers are assigned when the total desired delivery volumes of occasional delivery workers exceeds the total volume of delivery tasks exceeds total parcel volumes of delivery tasks. By choosing Maximum Candidate Assignment, transportation system 107 chooses the minimum value of each range for each occasional delivery worker.

In step 306, transportation system 107 may select a scheduling type for delivery assignments. The scheduling type may include delivery task basis, delivery worker basis, sub-route basis, delivery worker basis for sub-route, and drop off. The selection is made by a user device (not pictured) along with a request to execute the selected scheduling type for delivery assignments. The user device is associated with a worker in charge of assigning delivery tasks. For example, a worker selecting a scheduling type may include a manager associate with a fulfillment center 200. The selection may be transmitted from internal front end system 105. The internal front end system 105, as discussed above with respect to FIG. 1A, may enable internal users (e.g., employees of an organization) to interact with one or more systems in system 100.

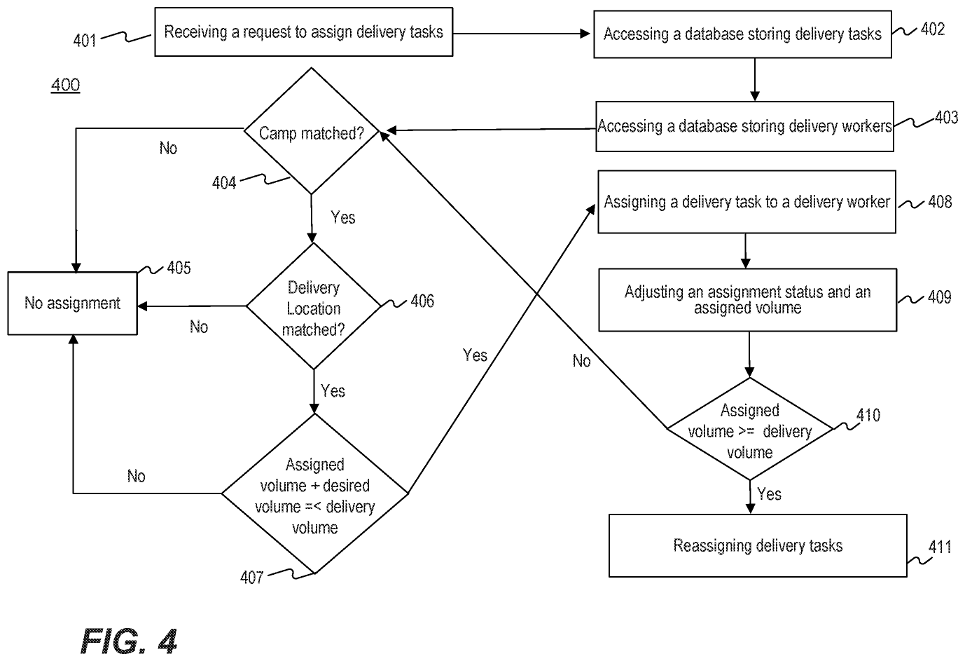

The delivery task basis, also known as preset basis, may assign delivery tasks to occasional delivery workers 224B and is further described below with respect to FIG. 4. For example, delivery task basis assigns a delivery task to occasional delivery workers 224B until all volumes of parcels associated with the delivery task is allocated. Once all the volumes are allocated, delivery task basis assigns next delivery task in same manner.

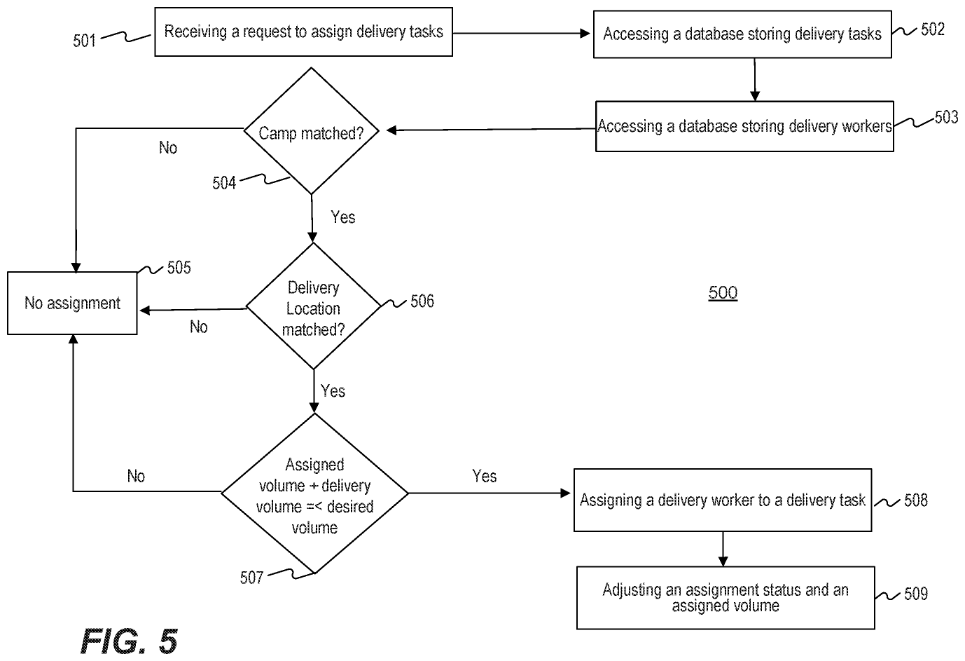

The delivery worker basis, also known as candidate basis, may assign occasional delivery workers 224B to delivery tasks and is further described below with respect to FIG. 5. For example, delivery worker basis assigns an occasional delivery worker 224B to delivery tasks until all desired delivery volumes associated with the delivery worker 224B are allocated. Once all the volumes are allocated, delivery worker basis assigns the next occasional delivery worker 224B in the same manner.

The sub-route basis may assign delivery tasks including sub-routes to occasional delivery workers 224B in the same manner as the delivery task basis and the delivery worker basis for sub-route may assign occasional delivery workers 224B to delivery tasks including sub-routes in the same manner as the delivery worker basis. However, delivery worker basis for sub-route may not assign a delivery worker to multiple delivery tasks. A delivery worker is assigned to only one delivery task because sub-routes comprises one or more neighboring destinations and assigning another sub-route would reduce the efficiency of the deliver worker. The drop-off may assign delivery tasks to occasional delivery workers 224B who volunteered for the drop-off tasks as indicated by the stored information described above with respect to step 302.

In step 307, transportation system 107 may execute the selected scheduling type on the stored information associated from step 302 and the stored delivery tasks from step 304.

In step 308, transportation system 107 may determine whether sufficient number of parcels are covered by executing the schedule type. Transportation system 107, in some embodiments, may determine the sufficiency automatically. For example, if transportation system 107 detects that unassigned delivery tasks are over a predefined threshold, transportation system 107 may determine that sufficient number of parcels are not covered by executing the schedule type. In another embodiment, a worker who is in charge of assigning delivery tasks may determine the sufficiency manually. For example, a worker associated with the user device may inspect the parcel coverage from executing a selected scheduling type and determine an execution of another scheduling type for the better coverage by transmitting another request for delivery assignments with different scheduling type to transportation system 107. If it was determined that there was not sufficient parcel coverage, in step 306, transportation system 107 may select another scheduling type. If it was determined that there was sufficient parcel coverage, in step 309, transportation system 107 may transmit the delivery assignments to the user device for a delivery assignments inspection. For example, delivery assignments provided by transportation system 107 may comprise any issues with the assignments. The issues may comprise a reason why an occasional delivery worker 224B is not assigned to any delivery tasks. The delivery assignments allow a worker associated with the user device to conveniently inspect any errors caused from executing a scheduling type for the delivery assignments.

In step 310, transportation system 107 may confirm the delivery assignments by receiving a confirmation from the user device. For example, a worker associated with the user device, after inspecting the delivery assignments in step 309, may confirm the assignments by transmitting a confirmation to the transportation system 107.

In step 311, transportation system 107 may transmit assigned delivery tasks to mobile devices (e.g., 107A-C) associated with the assigned occasional delivery workers 224B whose assignments have been confirmed in step 310. The transmitted delivery task may comprise a location to pick up parcels, a delivery volume, a delivery location, or any other information related to process the delivery.

In step 312, transportation system 107 may transmit the delivery assignments and information associated with the delivery assignments to the user device. The information enables a worker associated with the user device to monitor the status of delivery assignments.

FIG. 4 is an exemplary flow chart of process 400 for automatically assigning and reassigning delivery tasks to occasional delivery workers 224B (preset basis), consistent with the disclosed embodiments. This exemplary process is provided by way of example. Process 400 shown in FIG. 4 can be executed or otherwise performed by one or more combinations of various systems, but the preferred embodiment comprises executing process 400 on transportation system 107. Each block shown in FIG. 4 represents one or more processes, methods, or subroutines in the exemplary method 400. Referring to FIG. 4, exemplary method 400 may begin at block 401.

In step 401, transportation system 107 may receive a request to assign delivery tasks to a group of occasional delivery workers 224B (e.g., preset basis or sub-route basis) from a user device (not pictured). The user device is associated with a worker in charge of assigning delivery tasks. For example, a worker requesting delivery task assignments for occasional workers 224B may include a manager associate with a fulfillment center 200. The request may be transmitted from internal front end system 105. The internal front end system 105, as discussed above with respect to FIG. 1A, may enable internal users (e.g., employees of an organization) to interact with one or more systems in system 100. The worker may send a request multiple times until the worker decides to finalize the assignments as described above with respect to step 308 in FIG. 3. For example, a database storing delivery workers may be updated when the database receives a delivery task request from an occasional delivery worker and a worker in charge of assigning delivery tasks may process new delivery assignments based on the updated information associated with occasional delivery workers.

In step 402, transportation system 107 may access a database (not pictured) storing delivery tasks, the database is discussed above with respect to step 304 in FIG. 3. The database is described above as a database storing delivery tasks. Each of the delivery tasks may comprise properties including a delivery location, a volume of parcels, and a desired camp zone 215 associated with a FC 200 to pick up delivery parcels.

In some embodiments, transportation system 107 may sort the delivery tasks in descending order of the volume of parcels to prioritize delivery tasks with higher volumes for delivery assignments. For example, a delivery task with 100 parcels is assigned before another deliver task with 50 parcels.

In step 403, transportation system 107 may access a database storing information associated with occasional delivery workers 224B, the database is discussed above with respect to step 302 in FIG. 3. The database is described above as a database storing information associated with occasional delivery workers 224B. Each delivery worker is associated with an assignment status, one or more desired delivery areas, a desired delivery volume, and a desired camp zone.

Transportation system 107 may classify occasional delivery workers 224B with a status of loyal, new, rolling, or normal. The status may relate to a priority in receiving delivery tasks for occasional delivery workers 224B and may be based on how experienced the occasional delivery worker 224B is. Transportation system 107 may assign a loyal status occasional delivery worker to a delivery task before assigning a new status occasional delivery worker, wherein the new status occasional delivery worker is assigned to a delivery task before a rolling status occasional delivery worker, and the rolling status occasional delivery worker is assigned to a delivery task before a normal status occasional delivery worker. Occasional delivery worker 224B may obtain a loyal status by performing more than a predefined number of delivery tasks. Until the occasional delivery worker 224B reaches loyal status, rolling status is assigned to the occasional delivery worker 224B. In some embodiments, transportation system 107 may limit a number of new delivery workers for delivery assignments for efficiency. For example, transportation system 107 may limit a number of new delivery workers to not exceed 70% of total delivery workers available for delivery assignments. Transportation system 107 may remove new delivery workers whose requests were stored last. In some embodiments, transportation system 107 may also limit a desired delivery volume of new delivery worker. For example, transportation system 107 may limit a desired delivery volume of new delivery worker to 50. The status may also include black-list and transportation system 107 does not assign any delivery tasks to black-list occasional delivery workers.

In some embodiments, transportation system 107 may detect duplicated occasional delivery workers among the occasional delivery workers. The detection process may include one or more comparisons of phone numbers, names, or vehicle information. When the duplication is detected, transportation system 107 may remove information associated with a delivery request.

In some embodiments, transportation system 107 may validate vehicle information associated the occasional delivery workers. For example, transportation may parse vehicle information to evaluate whether a vehicle 226 associated with an occasional delivery worker 224B is corporate vehicle such as taxi. If the vehicle 226 is corporate vehicle, transportation system 107 may not assign a delivery task to the occasional delivery worker 224B.

In step 404, transportation system 107 may determine whether a camp zone associated with a first delivery task matches with a desired camp zone associated with a first occasional delivery worker. If the camp zones do not match, in step 405, transportation system 107 may not assign the first delivery task to the first occasional delivery worker.

If the camp zones match, in step 406, transportations system 107 may determine whether a delivery location of the first delivery task is within a desired delivery area of the first delivery worker. In some embodiment, transportation system 107 may prioritize delivery workers with limited desired delivery area over delivery workers with more broad delivery areas. For example, a delivery worker with three desired delivery areas is assigned before a delivery worker who would deliver for all areas. If the delivery location of the first delivery task is not within the desired delivery area of the first delivery worker, in step 405, transportation system 107 may not assign the first delivery task to the first occasional delivery worker.

If the delivery location of the first delivery task is within the desired delivery area of the first delivery worker, in step 407, transportation system 107 may determine whether a sum of an assigned volume for the first delivery task and a desired delivery volume of the first delivery worker is fewer than or equal to a volume of parcels of the first delivery task. The assigned volume is initially zero because the first delivery task is not assigned to any delivery workers, but the assigned volume is updated as more occasional delivery workers are assigned for the first delivery task. If the sum is greater than the volume of parcels, in step 405, transportation system 107 may not assign the first delivery task to the first occasional deliver worker. If the sum is fewer than or equal to the volume of parcels, in step 408, transportation system 107 may assign the first delivery task to the first delivery worker.

In step 409, transportation system 107 may adjust the assignment status of the first delivery worker to assigned and the assigned volume of parcels for the first delivery task by adding the desired delivery volume. For example, if a delivery task is not assigned to any delivery workers, an assigned volume of parcels for the delivery task is updated by simply adding a desired delivery volume of a first delivery worker assigned to the delivery task. By way of further example, if a delivery task is assigned to some delivery workers and corresponding assigned volume of parcels for the delivery task is 200, the assigned volume of parcels is updated to 250 when the delivery task is assigned to another occasional delivery worker 224B with a desired delivery volume of 50.

In step 410, transportation system 107 may determine whether the adjusted assigned volume of parcels from step 409 is greater than or equal to the volume of parcels of the first delivery task. If the adjusted assigned volume is fewer than the volume of parcels, in step 404, transportation may determine whether a camp zone associated with the first delivery task matches with a desired camp zone associated with a second occasional delivery worker. Transportation system 107 may repeat steps 404 to 410 until the system assigns all volume of parcels of the first delivery task to occasional delivery workers 224B. If the adjusted assigned volume is greater than or equal to the volume of parcels, in step 411, transportation system 107 may reassign the delivery tasks among assigned delivery workers by swapping the delivery tasks when the assigned volume of parcels of the delivery task is greater than or equal to the volume of parcels of the delivery task. If a delivery task is assigned to loyal or rolling delivery workers, then transportation system 107 preserves the delivery task and does not reassign the delivery task. Transportation system 107 may repeat steps 304 to 311 to assign remaining delivery tasks to remaining occasional delivery workers 224B.

FIG. 5 is an exemplary flow chart of process 500 for automatically assigning occasional delivery workers 224B to delivery tasks (candidate basis), consistent with the disclosed embodiments. This exemplary process is provided by way of example. Process 500 shown in FIG. 5 can be executed or otherwise performed by one or more combinations of various systems, but the preferred embodiment comprises executing process 500 on transportation system 107. Each block shown in FIG. 5 represents one or more processes, methods, or subroutines in the exemplary method 500. Referring to FIG. 5, exemplary method 500 may begin at block 501.

In step 501, transportation system 107 may receive a request to assign a group of occasional delivery workers 224B to delivery tasks (e.g., candidate basis) from a user device (not pictured). The user device is associated with a worker in charge of assigning delivery tasks. For example, a worker requesting delivery task assignments for occasional workers 224B may include a manager associate with a fulfillment center 200. The request may be transmitted from internal front end system 105. The internal front end system 105, as discussed above with respect to FIG. 1A, may enable internal users (e.g., employees of an organization) to interact with one or more systems in system 100. The worker may send a request multiple times until the worker decides to finalize the assignments as described above with respect to step 308 in FIG. 3. For example, a database storing delivery workers may be updated when the database receives a delivery task request from an occasional delivery worker and a worker in charge of assigning delivery tasks may process new delivery assignments based on the updated information associated with occasional delivery workers.

In step 502, transportation system 107 may access a database (not pictured) storing delivery tasks, the database is discussed above with respect to step 304 in FIG. 3. The database is described above as a database storing delivery tasks. Each of the delivery tasks may comprise properties including a delivery location, a volume of parcels, and a desired camp zone 215 associated with a FC 200 to pick up delivery parcels.

In some embodiments, transportation system 107 may sort the delivery tasks in descending order of the volume of parcels to prioritize delivery tasks with higher volumes for delivery assignments. For example, a delivery task with 100 parcels is assigned before another deliver task with 50 parcels.

In step 503, transportation system 107 may access a database storing information associated with occasional delivery workers 224B, the database is discussed above with respect to step 302 in FIG. 3. The database is described above as a database storing information associated with occasional delivery workers 224B. Each delivery worker is associated with an assignment status, one or more desired delivery areas, a desired delivery volume, and a desired camp zone.

Transportation system 107 may classify occasional delivery workers 224B with a status of loyal, new, rolling, or normal. The status may relate to a priority in receiving delivery tasks for occasional delivery workers 224B. Transportation system 107 may assign a loyal status occasional delivery worker to a delivery task before assigning a new status occasional delivery worker, wherein the new status occasional delivery worker is assigned to a delivery task before a rolling status occasional delivery worker, and the rolling status occasional delivery worker is assigned to a delivery task before a normal status occasional delivery worker. Occasional delivery worker 224B may obtain a loyal status by performing delivery tasks over a predefined number. Until the occasional delivery worker 224B reaches the loyal status, rolling status is assigned to the occasional delivery worker 224B. In some embodiments, transportation system 107 may limit a number of new delivery workers for delivery assignments for efficiency. For example, transportation system 107 may limit a number of new delivery workers to not exceed 70% of total delivery workers available for delivery assignments. Transportation system 107 may remove new delivery workers whose requests were stored last. In some embodiments, transportation system 107 may also limit a desired delivery volume of new delivery worker. For example, transportation system 107 may limit a desired delivery volume of new delivery worker to 50. The status may also include black-list and transportation system 107 does not assign any delivery tasks to black-list occasional delivery workers.

In some embodiments, transportation system 107 may detect duplicated occasional delivery workers among the occasional delivery workers. The detection process may include one or more comparisons of phone numbers, names, or vehicle information. When the duplication is detected, transportation system 107 may remove information associated with a delivery request.

In some embodiments, transportation system 107 may validate vehicle information associated the occasional delivery workers. For example, transportation may parse vehicle information to evaluate whether a vehicle 226 associated with an occasional delivery worker 224B is corporate vehicle such as taxi. If the vehicle 226 is corporate vehicle, transportation system 107 may not assign a delivery task to the occasional delivery worker 224B.

In step 504, transportation system 107 may determine whether a camp zone associated with a first delivery task matches with a desired camp zone associated with a first occasional delivery worker. If the camp zones do not match, in step 505, transportation system 107 may not assign the first occasional delivery worker to the first delivery task.

If the camp zones match, in step 506, transportation system 107 may determine whether a delivery location of the first delivery task is within a desired delivery area of the first delivery worker. In some embodiment, transportation system 107 may prioritize delivery workers with limited desired delivery area over delivery workers with more broad delivery areas. For example, a delivery worker with three desired delivery areas is assigned before a delivery worker who would deliver for all areas. If the delivery location of the first delivery task is not within the desired delivery area of the first delivery worker, in step 505, transportation system 107 may not assign the first occasional delivery worker to the first delivery task.

If the delivery location of the first delivery task is within the desired delivery area of the first delivery worker, in step 507, transportation system 107 may determine whether a sum of an assigned volume for the first delivery worker and a volume of parcels of the first delivery task is fewer than or equal to a desired delivery volume of the first delivery worker. The assigned volume is initially zero because the first delivery worker is not assigned to any delivery tasks, but the assigned volume is updated as more delivery tasks are assigned for the first delivery worker. If the sum is greater than the desired volume, in step 505, transportation system 107 may not assign the first occasional delivery worker to the first delivery task. If the sum is fewer than or equal to the desired volume, in step 508, transportation system 107 may assign the first delivery worker to the first delivery task.

In step 509, transportation system 107 may adjust the assignment status of the first task to assigned and the assigned volume for the first delivery worker by adding the volume of parcels of the first delivery task. For example, if a delivery worker is not assigned to any delivery tasks, an assigned volume for the delivery worker is updated by simply adding a volume of parcel of a first delivery task. By way of further example, if a delivery worker is assigned to some delivery tasks and corresponding assigned volume of parcels for the delivery worker is 200, the assigned volume of parcels for the delivery worker is updated to 250 when the delivery worker is assigned to another delivery task with 50 parcels.

FIG. 6A depicts exemplary information associated with occasional delivery workers stored in a database (not pictured), consistent with the disclosed embodiments. The preferred embodiment comprises storing the disclosed information in the form of a table, but one of ordinary skill will understand that other forms are possible. The information may include a name, a status, a phone number, a vehicle information, a desired camp storing delivery parcels for the delivery worker to pick up the parcels, one or more desired delivery areas, a desired range of delivery volume, an indicator for drop-off tasks, or other preferences from the delivery worker.

FIG. 6B depicts exemplary delivery tasks stored in a database (not pictured), consistent with the disclosed embodiments. The preferred embodiment comprises storing the disclosed information in the form of a table, but one of ordinary skill will understand that other forms are possible. Each of the delivery tasks may include a delivery location, a volume of parcels, an identifier associated with a delivery task, a camp, and an identifier associated with the camp, or other information.

FIG. 6C depicts exemplary delivery tasks comprising sub-routes stored in a database (not pictured), consistent with the disclosed embodiments. The preferred embodiment comprises storing the disclosed information in the form of a table, but one of ordinary skill will understand that other forms are possible. The each of the delivery tasks may include a delivery location, a volume of parcels, an identifier associated with a delivery task, a camp, and an identifier associated with the camp, or other information, wherein the delivery location comprises one or more neighboring delivery destinations.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for providing delivery assignment, comprising:
a network;
one or more memory devices storing instructions;
one or more processors configured to execute the instructions to perform operations comprising:
receiving a request to assign delivery tasks to a group of delivery workers from a user device;
accessing a first database storing delivery tasks via the network, each delivery task associated with properties including a delivery location, a volume of parcels, and an assigned volume of parcels;
accessing a second database storing information associated with delivery workers via the network, each delivery worker associated with one or more desired delivery areas, and a desired delivery volume;
executing a first scheduling type, the first scheduling type being one of:
a delivery task basis for assigning delivery tasks to delivery workers, and
a delivery worker basis for assigning delivery workers to delivery tasks;
determining, based on assigning the tasks and workers using the first scheduling type, a comparison between the number of unassigned delivery tasks; and
based on the comparison:
transmitting the assignments via the network to the user device; or
executing a second scheduling type, the second scheduling type being different from the first scheduling type,
wherein each delivery worker is associated with a status of loyal, new, rolling, or normal and further wherein assigning the first delivery task to a first delivery worker further comprises:
determining whether available delivery workers comprise a loyal delivery worker;
assigning the loyal delivery worker to the delivery task when it is determined that the available delivery workers comprise the loyal delivery worker;
determining whether the available delivery workers comprise a new delivery worker when it is determined that the available delivery workers do not comprise the loyal delivery worker;
assigning the new delivery worker to the delivery task when it is determined that the available delivery workers comprise the new delivery worker;
determining whether the available delivery workers comprise a rolling delivery worker when it is determined that the available delivery workers do not comprise the new delivery worker;
assigning the rolling delivery worker to the delivery task when it is determined that the available delivery workers comprise the rolling delivery worker;
determining whether the available delivery workers comprise a normal delivery worker when it is determined that the available delivery workers do not comprise the rolling delivery worker; and
assigning the normal delivery worker to the delivery task when it is determined that the available delivery workers comprise the normal delivery worker.

2. (canceled)

3. The system of claim 1, wherein executing the first scheduling type comprises reassigning the delivery task, the reassignment comprising preserving the delivery tasks assigned to the loyal and rolling delivery workers.

4. The system of claim 1, wherein the desired delivery volume of new delivery workers is limited by a predefined volume.

5. The system of claim 1, wherein the desired delivery volume associated with a delivery worker comprises a desired range of delivery volume and wherein the operations further comprise choosing a maximum value or a minimum value of the desired range.

6. The system of claim 5, wherein choosing a maximum value or minimum value of the desired range comprises choosing a maximum value when the total volume of delivery parcels for all delivery tasks is more than the total desired delivery volume of all delivery workers and choosing a minimum value when the total volume of delivery parcels for all delivery tasks is less than the total desired delivery volume of all delivery workers.

7. The system of claim 1, wherein the operations further comprise sorting the delivery tasks in descending order of the volume of parcels to prioritize delivery tasks with greater volumes for delivery assignments.

8. (canceled)

9. The system of claim 1, wherein executing the first scheduling type comprises prioritizing a delivery worker with limited desired delivery areas for delivery assignments.

10. The system of claim 1, wherein a delivery task is not assigned to a delivery worker associated with a black-list status.

11. The system of claim 1, wherein the delivery worker is removed from the second database when the delivery worker is listed in the second database multiple times.

12. A computer-implemented method for providing delivery assignment, comprising:
a network;
one or more memory devices storing instructions;
one or more processors configured to execute the instructions to perform operations comprising:
receiving a request to assign a group of delivery workers to delivery tasks from a user device;
accessing a first database via the network storing delivery tasks, each delivery task associated with properties including a delivery location and a volume of parcels;
accessing a second database storing information associated with delivery workers via the network, each delivery worker associated with an assignment status, one or more desired delivery areas, a desired delivery volume, and an assigned volume of parcels;
executing a first scheduling type, the first scheduling type being one of:
a delivery task basis for assigning delivery tasks to delivery workers, and
a delivery worker basis for assigning delivery workers to delivery tasks;
determining, based on assigning the tasks and workers using the first scheduling type, a comparison between the number of unassigned delivery tasks;
based on the comparison:
transmitting the assignments via the network to the user device; or
executing a second scheduling type, the second scheduling type being different from the first scheduling type,
wherein each delivery worker is associated with a status of loyal, new, rolling, or normal and further wherein assigning the first delivery task to a first delivery worker further comprises:
determining whether available delivery workers comprise a loyal delivery worker;
assigning the loyal delivery worker to the delivery task when it is determined that the available delivery workers comprise the loyal delivery worker;
determining whether the available delivery workers comprise a new delivery worker when it is determined that the available delivery workers do not comprise the loyal delivery worker;
assigning the new delivery worker to the delivery task when it is determined that the available delivery workers comprise the new delivery worker;
determining whether the available delivery workers comprise a rolling delivery worker when it is determined that the available delivery workers do not comprise the new delivery worker;
assigning the rolling delivery worker to the delivery task when it is determined that the available delivery workers comprise the rolling delivery worker;
determining whether the available delivery workers comprise a normal delivery worker when it is determined that the available delivery workers do not comprise the rolling delivery worker; and
assigning the normal delivery worker to the delivery task when it is determined that the available delivery workers comprise the normal delivery worker.

13. (canceled)

14. The method of claim 12, wherein the desired delivery volume of new delivery worker is limited by a predefined volume.

15. The method of claim 12, wherein the desired delivery volume associated with a delivery worker comprises a desired range of delivery volume and wherein the operations further comprise choosing a maximum value or a minimum value of the desired range.

16. The method of claim 15, wherein choosing a maximum value or minimum value of the desired range comprises choosing a maximum value when the total volume of delivery parcels for all delivery tasks is more than the total desired delivery volume of all delivery workers and choosing a minimum value when the total volume of delivery parcels for all delivery tasks is less than the total desired delivery volume of all delivery workers.

17. The method of claim 12, wherein the operations further comprise sorting the retrieved delivery tasks in descending order of the volume of parcels to prioritize delivery tasks with higher volumes for delivery assignments.

18. (canceled)

19. The method of claim 12, wherein a delivery worker with limited desired delivery areas is prioritized for delivery assignments.

20. A computer-implemented system for providing delivery assignment, comprising:
a network;
one or more memory devices storing instructions;
one or more processors configured to execute the instructions to perform operations comprising:
receiving a request to assign delivery tasks to a group of delivery workers from a user device;
accessing a first database via the network storing delivery tasks, each delivery task associated with properties including a delivery location, a volume of parcels, and an assigned volume of parcels, wherein the delivery location includes one or more neighboring destinations;
accessing a second database storing information associated with delivery workers via the network, each delivery worker associated with an assignment status, one or more desired delivery areas, and a desired delivery volume;
executing a first scheduling type, the first scheduling type being one of:
a delivery task basis for assigning delivery tasks to delivery workers, and
a delivery worker basis for assigning delivery workers to delivery tasks;
determining, based on assigning the tasks and workers using the first scheduling type, a comparison between the number of unassigned delivery tasks;
based on the comparison:
transmitting the assignments via the network to the user device; or
executing a second scheduling type, the second scheduling type being different from the first scheduling type,
wherein each delivery worker is associated with a status of loyal, new, rolling, or normal and further wherein assigning the first delivery task to a first delivery worker further comprises:
determining whether available delivery workers comprise a loyal delivery worker;
assigning the loyal delivery worker to the delivery task when it is determined that the available delivery workers comprise the loyal delivery worker;
determining whether the available delivery workers comprise a new delivery worker when it is determined that the available delivery workers do not comprise the loyal delivery worker;
assigning the new delivery worker to the delivery task when it is determined that the available delivery workers comprise the new delivery worker;
determining whether the available delivery workers comprise a rolling delivery worker when it is determined that the available delivery workers do not comprise the new delivery worker;
assigning the rolling delivery worker to the delivery task when it is determined that the available delivery workers comprise the rolling delivery worker;
determining whether the available delivery workers comprise a normal delivery worker when it is determined that the available delivery workers do not comprise the rolling delivery worker; and
assigning the normal delivery worker to the delivery task when it is determined that the available delivery workers comprise the normal delivery worker.
